(19) United States
(12) Patent Application Publication
(10) Pub. No.: US 2026/0259020 A1
(43) Pub. Date: Sep. 3, 2026

(54) PLATE-FIN HEAT EXCHANGER, METHOD FOR PRODUCING A PLATE-FIN HEAT EXCHANGER AND METHOD USING A PLATE-FIN HEAT EXCHANGER

(71) Applicant: LINDE GMBH, Pullach (DE)

(72) Inventors: Axel LEHMACHER, Pullach (DE); Sebastian ULMER, Pullach (DE); Paul HEINZ, Pullach (DE); Alexander WOITALKA, Pullach (DE); Dino MEHANOVIC, Pullach (DE)

(21) Appl. No.: 18/878,414

(22) PCT Filed: Jun. 29, 2023
(86) PCT No.: PCT/EP2023/025300

§ 371 Date: Dec. 23, 2024

(30) Foreign Application Priority Data
Jun. 30, 2022 (EP) 22020312.9

(51) Int. Cl. F28F 27/00; F28D 9/00

(52) U.S. Cl. CPC F28F 27/00; F28D 9/0062

(57) ABSTRACT

A plate-fin heat exchanger which has a heat exchanger block is proposed, wherein heat exchanger passages which each have distribution and collecting structures and one or more central structured sheets which are arranged between the distribution and collecting structures are arranged in the heat exchanger block, wherein separating structures, are arranged between the heat exchanger passages and the heat exchanger block is covered on a first side and on a second side by covering structures. It is provided here that at least one of the separating structures and/or at least one of the covering structures are/is designed as a leak detection structure which has a cavity formed in the leak detection structure in such a manner that the cavity is delimited in the direction of the first side by a first material layer and in the direction of the second side by a second material layer of the leak detection structure.

The invention relates to a plate-fin heat exchanger, a method for producing a corresponding plate-fin heat exchanger, and a method in which a corresponding plate-fin heat exchanger is used.

### BACKGROUND OF THE INVENTION

Brazed aluminum plate-fin heat exchangers (PFHE; designations according to the German and English edition of ISO 15547-2:3005) can be used in a large number of process plants at very different pressures and temperatures. For example, they are used in cryogenic air separation, in the liquefaction of natural gas and in ethylene production plants. Whenever the term “heat exchanger” or “plate heat exchanger” is used below for short, this always refers to a corresponding brazed plate-fin heat exchanger which can be made in particular of aluminum, but also of other materials. It is understood that the term “aluminum” can also refer to an aluminum alloy.

The mentioned plate heat exchangers differ significantly in terms of their design from heat exchangers of the printed circuit heat exchanger (PCHE) type. The latter are compact plate heat exchangers which usually have a core that is made up of metal plates with chemically etched flow channels. After the flow channels have been formed, the metal plates are placed one on top of the other in a precisely fitting manner and then bonded to form a solid metal block by diffusion welding.

WO 97/03281 A1, for example, proposes the use of such a printed circuit heat exchanger to be advantageous for operation with a gas turbine.

The gas turbine is equipped with a corresponding heat exchanger in which heat is removed from compressed air that is taken from the compressor part and used to cool the turbine part. The heat exchanger transfers the heat from the cooling air to a fluid that is to be injected back into the combustion section of the gas turbine, such as fuel, without the use of an intermediate heat transfer fluid. The heat extracted from the cooling air is returned to the circuit when the fluid is introduced into the combustion chamber of the gas turbine.

The service life of corresponding plate-fin heat exchangers depends in particular on the occurrence of strong thermal gradients and mechanical stresses induced thereby. Structural weakening resulting from mechanical stresses can accumulate and ultimately lead to leaks in the field. In plate-fin heat exchangers, stresses and leaks can occur, in particular inside and outside the field of vision so that they may not be detectable early enough. Leaks lead to an unplanned shutdown of a corresponding plant with loss of production, which massively increases the overall costs of remedial measures.

EP 3 704 431 A1 proposes a plate-fin fluid processing device with active layers, wherein each active layer comprises a plate fin that is arranged sandwich-like between separating sheets so that an active fluid space is defined between the separating sheets. The active layers comprise an outermost active layer having an inlet and an outlet. The outermost active layer is followed by a layer structure with a plate fin which is arranged between a separating sheet and a cap sheet. The layer structure has a sealed fluid space. A pressure monitoring system is connected to the fluid space of the layer structure. A pressure relief device is designed to relieve pressure within the fluid space when a preset pressure is exceeded.

The present invention has the object of improving the detection of leaks in a plate-fin heat exchanger of the described type.

### DISCLOSURE OF THE INVENTION

This object is achieved by a plate-fin heat exchanger, a method for producing a corresponding plate-fin heat exchanger, and a method in which a corresponding plate-fin heat exchanger is used, having the respective features of the independent patent claims. Embodiments are the subject matter of the dependent claims and of the following description.

According to the invention, a plate-fin heat exchanger is proposed which has a heat exchanger block, wherein heat exchanger passages which each have distribution and collecting structures, in particular in the form of corresponding structured sheets, and one or more central structured sheets, which are arranged between the distribution and collecting structures, are arranged in the heat exchanger block, and wherein separating structures are arranged between the heat exchanger passages, and the heat exchanger block is covered on an upper side or first side, and on a lower side or second side, by covering structures arranged parallel to the separating structures. The separating and covering structures can, on the one hand, be conventional separating or cap sheets, but any of these separating and covering structures can also be a modified separating or covering structure provided according to an embodiment of the invention, which is designed as a leak detection structure. At least one such leak detection structure is provided. Thus, in embodiments of the invention, at least one of the separating structures and/or at least one of the covering structures can be designed as a leak detection structure.

It is provided for a corresponding leak detection structure to have a cavity which is formed in the leak detection structure such that the cavity is delimited in the direction of the first side of the heat exchanger block by a first material layer and in the direction of the second side of the heat exchanger block by a second material layer of the leak detection structure. It shall be appreciated that in embodiments of the invention, several cavities can also be provided, wherein the following explanations apply to each of the cavities.

In a region of the leak detection structure not taken up by the cavity, the first material layer and the second material layer can be connected to each other via a solder layer or via one or more intermediate elements or intermediate layers, or they can merge into one another in one piece. However, no intermediate structural sheets are provided as is the case, for example, in EP 3 704 431 A1 with an “active layer” used therein. In this way, the installation space is significantly reduced, and manufacturing costs and effort are reduced. The first material layer and the second material layer, if they are not formed in one piece, can abut directly against one another so that they may only be separated from one another by a solder layer. Alternatively, an intermediate layer can also be provided which, in the region of the cavity, can have a recess defining the cavity.

A width of the cavity in a direction parallel to the first and second material layer is less than a width, in particular a total width, of the central structured sheet(s) of the heat exchanger passages in that same direction. The “width” represents in particular the smallest extension in a corresponding direction. It is, in particular, the dimension perpendicular to a longitudinal extension. It is, in particular, less than 1/50, 1/10 or ⅕ and, for example, more than 1/100 of the width of the structured sheet(s). In case of a, for example, meandering, sinusoidal or other periodic configuration, an amplitude in the mentioned direction can also be correspondingly smaller than the width of the structured sheet(s).

Furthermore, it is intended for a measuring device to be provided which is designed to detect a variable that correlates to a rupture of a wall of the cavity or of an element arranged in the cavity. A corresponding rupture in a wall can in particular cause fluid to flow into the cavity and/or fluid to flow out of the cavity so that in that case, a pressure loss or an increase in pressure in particular characterizes a corresponding rupture and can be detected in corresponding embodiments of the invention. In other embodiments of the invention, a structure can be introduced into the cavity, for example an optical waveguide or an (in particular insulated) cable, the rupture of which can be detected by detecting an interruption of a light or current signal.

As understood herein, the term “upper side” refers to the outward-facing surface of a heat exchanger block which is formed by one of its cap sheets, and “lower side” refers to the outward-facing surface of the heat exchanger block which is formed by the other cap sheet. The upper side and lower side can be parallel to each other and also parallel to the separating sheets or the (largest) surfaces thereof and to the cap sheets or the (largest) surfaces thereof. Depending on the type of production, such parallelism is not a mandatory requirement. The terms “in the direction of the upper side” and “in the direction of the lower side” refer to directions that are perpendicular to planes that are aligned parallel to the separating sheets and cap sheets, or within which the separating sheets and cap sheets lie. The direction indicated with respect to the width of the cavity extends in particular perpendicular to the directions in the direction of the upper and lower side.

An orientation of the corresponding directions is indicated by specifying the target (“in the direction of the upper side” or “in the direction of the lower side”). Alternatively, both directions can also be defined as directions that are each perpendicular to a plane spanned by each relevant separating sheet (or its surface) and oriented in opposite directions to each other.

The terms “first side” and “second side” can also be used instead of the terms “upper side” and “lower side” so that the specification “in the direction of the upper side” can also be replaced by “in the direction of the first side” or “in a first direction.” The same applies to the term “in the direction of the upper side” which can be replaced by “in the direction of the second side” or “in a second direction.” The upper and lower sides can also be arranged in the front and back, left and right, etc. during operation of a corresponding heat exchanger block and should not be understood to be limiting.

In one embodiment of the invention, the first material layer can be formed by a first sheet and the second material layer by a second sheet, wherein in that case, the cavity can be provided by a recess in a surface of the first sheet facing in the direction of the second side and/or by a recess in a surface of the second sheet facing in the direction of the first side. If corresponding recesses are provided in both sheets, they form the cavity in particular together and are accordingly aligned one above the other. In other embodiments, as mentioned, the first material layer and the second material layer can also be connected to one another via an intermediate layer, in particular an intermediate sheet, wherein a recess formed in the intermediate layer can define the cavity.

The first sheet and the second sheet can be (brazed) soldered or otherwise connected to each other in the region of the leak detection structure not taken up by the cavity. The same applies to any intermediate layer that may be present. The mentioned recess(es) can be formed in particular by embossing or material removal, for example laser ablation, milling, erosion, etc.

In this embodiment, a corresponding sheet arrangement thus comprises, in particular between at least two of the heat exchanger passages, two sheets without a structural sheet arranged therebetween, which together form a separating sheet (in the form of a double sheet), and/or a corresponding sheet arrangement on the upper side and/or on the lower side of the heat exchanger block comprises in particular two sheets without a structural sheet arranged therebetween, which together form a cap sheet (in the form of a double sheet).

Hence, in such embodiments of the present invention, in particular a double separating sheet or cap sheet is used as a leak detection structure in order to insert a hollow volume or a control volume, for example in a dedicated manner below side bars (as explained in detail below). For example, the volume is pressure-monitored so that a tear in one of the separating sheets or cap sheets, especially in the region of the side bars, and a penetration or outflow of fluid can be detected via a pressure change in the control volume. The size of the volume and thus, for example, the weakening of the side bars is selected such that the double separating sheet or cap sheet with control volume below the side bars has a similar or slightly lower mechanical stability than a single separating sheet or cap sheet.

In other embodiments of the invention, the first material layer and the second material layer can also be parts of an integrally formed metal structure in which the cavity is formed or cut out. For example, a single separating sheet or cap sheet or a modified metal structure can also be used in which a cavity has been introduced into the separating sheet by suitable manufacturing methods or which has been manufactured with a cavity by suitable manufacturing methods (e.g., casting, additive manufacturing methods of any kind). Combinations of double sheets and single sheets can also be used.

The present invention makes it possible to early and reliably detect leaks and other damages such as cracks. For example, in contrast to the prior art explained at the outset, the solution proposed according to the invention can be implemented in a technically simpler manner and with smaller space requirements.

In an already mentioned embodiment of the invention, the variable that correlates with a rupture of a wall of the cavity or of an element arranged in the cavity can be a variable which characterizes an inflow of fluid into the cavity and/or an outflow of fluid from the cavity. In relation to corresponding embodiments, it will be referred to below as a pressure in the cavity, which increases when fluid flows into the cavity and decreases when fluid flows out of the cavity. However in such embodiments, the cavity can also be monitored using measuring methods that are based on optical, magnetic, electromagnetic, or acoustic effects. The physical effects that are monitored may require the introduction of suitable transmission materials (e.g., glass fibers). For the sake of simplicity only, reference will be made below to one pressure value.

In one embodiment of the present invention, the measuring device has a computing unit or is connected or connectable to a computing unit, wherein the computing unit is designed to monitor the variable, for example the pressure in the cavity, an electrical signal, an optical signal or the like, and is further designed to detect, on the basis of this monitored variable, a leak in the heat exchanger block or a rupture in one of the mentioned structures. A corresponding leak detection can, for example, be based on a threshold comparison and can include any signal processing methods, for example a determination of a moving average in order to eliminate short-term fluctuations in the variable. Alternatively or additionally, data-driven models and machine learning methods can also be used in this context.

In embodiments of the present invention, if corresponding double sheets (with a first and a second sheet) are used, the cavity can be formed by a recess, as mentioned, in one of these sheets or by recesses in both sheets facing each other. In the first alternative, for example, only one of the sheets needs to be weakened or extensively machined, whereas in the second alternative, a larger cavity can be created. If there is a recess in an intermediate sheet, the upper and lower sheets remain unweakened.

In embodiments of the present invention, the cavity in the leak detection structure can run alternately on two sides of a center line. It can be, in particular, a channel that meanders or runs in a zigzag shape. The center line can in particular lie parallel between an upper side and a lower side of the respective leak detection structure. As mentioned, however, parallelism is not required. In an embodiment with two sheets, the one recess or at least one of the recesses facing each other in the two sheets can run alternately on two sides of a corresponding center line, at least in one section. As explained in more detail with reference to FIG. 3 below, crack propagation can be limited in this way. In that case, an embodiment may be advantageous in which the center line runs parallel to a side edge of the respective separating sheet and/or cap sheet. But this is not mandatory. It may also be provided, however, for the center line to run (instead) parallel or in another suitable orientation to a predicted crack propagation line or a region of expected crack formation. The region of expected crack formation can be determined, for example, by simulations.

The recess or a corresponding cavity in general, which runs alternately on two sides of a center line at least in one section, can run in a meandering, sinusoidal, wave-shaped, or zigzag-shaped manner in embodiments of the present invention, in particular in a plane parallel to the upper and lower side of the leak detection structure and thus parallel to the first and second side of the heat exchanger block or the separating and cap sheets. However in this case, other suitable orientations are possible at any time. The selection made in each case can be based in particular on simplification of manufacturing technology or mechanical strength. In particular, the width of a corresponding amplitude parallel to the first and second material layer is also smaller than the width of the structural sheets in this direction.

In one embodiment of the present invention, side bars can be arranged on two sides of the central structured sheet(s) in the heat exchanger passages. In a vertical projection onto a plane arranged in particular (but not necessarily) parallel to the first and second side of the heat exchanger block or the separating structures and covering structures or their surface(s), the projection surfaces of the separating structures and covering structures overlap in particular substantially completely. The corresponding projection surfaces of the side bars overlap with peripheral regions of the separating structures and covering structures or their projection surfaces, as is usual in this respect for plate-fin heat exchangers. In a corresponding vertical projection, a transition region between at least one of the side bars and at least one of the structured sheets can overlap with the cavity in at least one section. The transition region can in particular be a substantially straight line at which a side bar abuts the corresponding structural sheet of the heat exchanger passage. Such a line can thus intersect a projection surface of the cavity in a corresponding vertical projection. Such an arrangement can ensure in particular that the particularly leak-prone regions in the transition region between side bars and structural sheets or the region of the separating and cap sheets covered thereby can be provided with the leak detection options provided according to the invention. However, alternative embodiments are also possible in which, in the mentioned vertical projection, either only the projection surfaces of at least one of the side bars or only at least one of the structured sheets overlap with the projection surface of the cavity.

In one embodiment of the present invention, the cavity can be connected to a drainage device in order to ensure that liquid flows out in the event of any leaks and in this way, for example, prevent excess pressure. A corresponding drainage device can also be designed, for example, for an opening above a predetermined pressure threshold.

In a plate-fin heat exchanger according to an embodiment of the present invention, it can be provided for temperature detection means or any other measuring means for detecting a temperature or any other measured values to be incorporated in the heat exchanger block.

Moreover, in a plate-fin heat exchanger of the explained type, in an embodiment of the invention also already mentioned, a structure such as an insulated cable or an optical fiber for crack detection can be arranged in the cavity or at any other location, which structure is fastened in such a way that it is interrupted when a crack occurs. A resistance value or a current flow through the cable can be monitored so that if there is a corresponding interruption, this can (additionally) suggest a crack. This means that a variable that correlates with a rupture of an element arranged in the cavity is detected, wherein the rupture, as mentioned, can be detected by detecting an interruption of a light or current signal.

In embodiments of the present invention, in addition to the cavity formed in the explained manner, a further cavity of the same or different design can also be arranged in the leak detection structure, wherein the cavities can be arranged in the leak detection structure without mutual connection to each other. Sections of the two cavities can be arranged alternately to each other or can alternately intersect an axis.

A method for producing a plate-fin heat exchanger that has a heat exchanger block is also the subject of the present invention. The method comprises forming a stack assembly that comprises a number of heat exchanger passages, wherein the heat exchanger passages are each formed by arranging a number of distribution and collecting structures and central structured sheets, wherein separating structures are each arranged between the heat exchanger passages, and wherein a covering structure each is arranged on a first side and a second side of the stack assembly. The method further includes connecting the stack assembly to form a heat exchanger block.

According to the invention, at least one of the separating structures and/or at least one of the covering structures is provided as a leak detection structure having a cavity which is arranged in the leak detection structure in such a way that the cavity is delimited in the direction of the first side by a first material layer and in the direction of the second side by a second material layer of the leak detection structure, wherein, in a region of the leak detection structure not taken up by the cavity, the first material layer and the second material layer are connected to each other. A width of the cavity in a direction parallel to the first and second material layer is less than a width of the central structured sheets of the heat exchanger passages in that same direction, i.e., of one or more structured sheets in one or more of the heat exchanger passages. Furthermore, it is intended for a measuring device to be provided which is designed to detect a variable that correlates with a rupture of the cavity or an element arranged in the cavity. The method may in particular comprise the provision of the features previously explained in detail according to the different embodiments of the present invention.

A method for controlling the temperature of at least one fluid, in which a plate-fin heat exchanger is used as previously explained in embodiments is also the subject of the invention.

For features and advantages of the aforementioned methods and embodiments thereof, express reference is made to the above explanations of the plate-fin heat exchanger according to the invention and its embodiments since they equally apply to the respective methods carried out and to the corresponding products.

The invention will be described in more detail below with reference to the accompanying drawings which illustrate embodiments of the present invention.

### BRIEF DESCRIPTION OF THE DRAWINGS

FIG. 1 illustrates a plate-fin heat exchanger.

FIG. 2 illustrates aspects of an embodiment of the present invention.

FIG. 3 illustrates aspects of an embodiment of the present invention.

FIG. 4 illustrates aspects of an embodiment of the present invention.

FIG. 5 illustrates aspects of an embodiment of the present invention.

FIG. 6 illustrates aspects of an embodiment of the present invention.

FIG. 7 illustrates aspects of an embodiment of the present invention.

### DETAILED DESCRIPTION OF THE DRAWINGS

In the figures, identical reference signs are used for elements that correspond to one another in terms of construction and/or function. Such elements are not explained repeatedly. If device features are explained below, the corresponding explanations apply equally to methods steps, and vice versa.

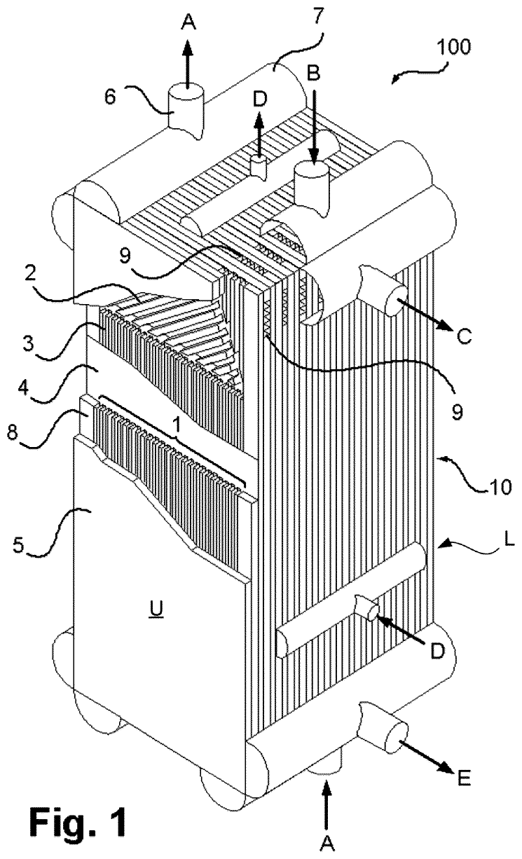

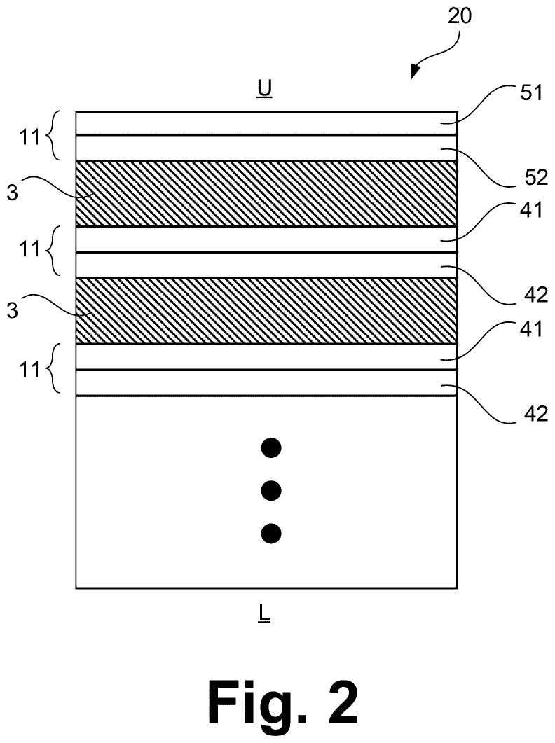

Brazed plate-fin heat exchangers made of aluminum are shown and described in FIG. 2 of above-mentioned ISO 15547-2:3005, as well as on page 5 of the ALPEMA publication “The Standards of the Brazed Aluminium Plate-Fin Heat Exchanger Manufacturers' Association,” 3rd edition, 2010. An illustration which substantially corresponds to the illustrations therein is shown in the attached FIG. 1 and will be explained below. The plate heat exchanger 100 shown partly open in FIG. 1 is used for the heat exchange of five different process media A to E in the shown example.

For heat exchange between the process media A to E, the plate heat exchanger 100 comprises a plurality of separating sheets 4 arranged in parallel with one another (in the previously mentioned publications, to which the subsequent references in brackets also refer, these are called “parting sheets” and also as parting structures in the present case), between which heat exchange passages 1 defined by structured sheets with fins 3 are formed, in each case for one of the process media A to E, and which can thereby enter into an exchange of heat with one another.

The structured sheets 3 are typically folded or corrugated, and flow channels are formed by each of the folds or corrugations, as also shown in FIG. 1 of the ISO 15547-2:3005. The provision of the structured sheets 3 offers the advantage of improved heat transfer, more targeted fluid guidance and an increase in the mechanical (tensile) strength. In the heat exchange passages 1, the process media A to E flow in particular separated by the separating sheets 4 but however, in case of perforated structured sheets 3, can optionally pass through the latter.

The individual passages 1 are surrounded on each side by what are known as side bars 8 which leave space free for feed and removal openings 9, however. The side bars 8 hold the separating sheets 4 at a distance and ensure mechanical reinforcement of the pressure chamber. Cover sheets 5 (“cap sheets”), which are in particular reinforced, are arranged in parallel with the separating sheets 4 and are used in particular to close off at least two sides.

By means of what are known as headers 7 which are provided with nozzles 6, the process media A to E are supplied and discharged via feed and removal openings 9. In the inlet region of the passages 1, there are further structured sheets 2 with what are known as distributor fins which ensure uniform distribution over the entire width of the passages 1. As seen in the direction of flow, further structured sheets 2 with collector fins can be located at the end of the passage 1 and lead the process media A to E from the passages 1 into the header 7 where they are collected and withdrawn via the corresponding nozzles 6. Herein, they are also referred to as “distribution and collecting structures”.

A heat exchanger block 10, which is cuboid in this case, is formed overall by the structured sheets 2 and 3, the side bars 8, the separating sheets 4 and the cap sheets 5, wherein a “heat exchanger block” is to be understood herein as the stated elements without the headers 7 and nozzles 6 in an interconnected state. As used herein, “upper side” or first side refers to the outward-facing surface of the heat exchanger block 10 which is formed by the one cap sheet 5, and “lower side” or second side refers to the outward-facing surface of the heat exchanger block 10 which is formed by the other cap sheet 5. In FIG. 1, the upper side or first side is marked U, the lower side or second side is concealed and indicated with L. As not illustrated in FIG. 1, the plate heat exchanger 100 can, in particular for manufacturing reasons, be formed from several cuboidal and interconnected heat exchanger blocks 10.

Plate heat exchangers 100 are brazed, for example, from aluminum. The passages 1 comprising the structured sheets 2 and 3, the separating sheets 4, the cap sheets 5, and the side bars 8, are in this case each provided with solder, stacked one on top of the other or accordingly arranged, and heated in an oven. The headers 7 and the nozzles 6 are welded onto the heat exchanger block 10 produced in this way.

FIG. 2 illustrates a structure according to one embodiment of the present invention and is designated as a whole by 20. The structure 20 represents part of a heat exchanger block 10 illustrated in FIG. 1, wherein the respective elements are not true to scale and are illustrated in cross section between the upper side or first side U and the lower side or second side L. A representation of the side bars 8 has been omitted herein. The arrangement continues downwards in substantially the same manner, as indicated by ellipsis ( . . . ) in FIG. 2. Any other continuation is also possible. So-called dummy layers (passages through which no flow occurs) can also be provided. They can also be present at the outer end of the active passages and abut on the cap sheets.

As illustrated by the arrangement 20, heat exchanger passages that were previously designated 1 are arranged in the heat exchanger block previously designated 10. Thereof, the structured sheets 3 are shown in FIG. 2. As illustrated in FIG. 2, two separating sheets 41, 42 are arranged between the heat exchanger passages 1 or the structural sheets 3 which, as illustrated with reference to the following figures, form a leak detection structure 11. The heat exchanger block 10 in the embodiment illustrated herein is furthermore covered on its upper side or first side U by two cap sheets 51, 52. As illustrated with reference to the following figures, they too form a leak detection structure, also designated 11 for the sake of simplicity. The lower side or second side L can be designed accordingly. In other words, double separating or cap sheets 41, 42 and 51, 52 are arranged here that each form leak detection structures 11.

In the following, features of embodiments of the present invention are illustrated with reference to FIGS. 2 to 5 using separating sheets 41, 42. The cap sheets 51, 52 can each be designed in the same or a comparable manner and are not explained in detail only for the sake of clarity.

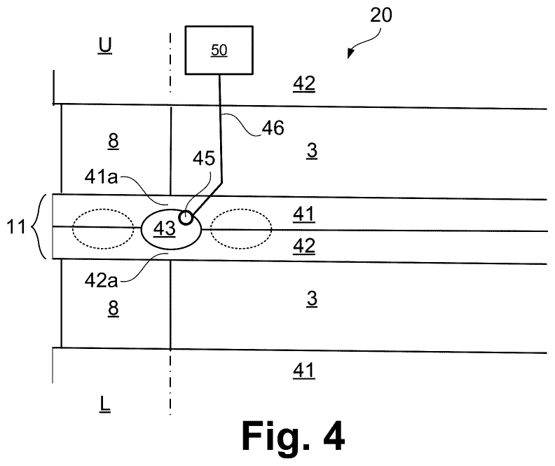

In FIG. 4, which will now be described in advance, a corresponding structure 20 is illustrated again, wherein in this case, the side bars 8 are also shown in addition to the structured sheets 3.

As can be seen in FIG. 4 or the arrangement illustrated herein, two separating sheets 41, 42 are arranged between at least two of the heat exchanger passages 1 without a structural sheet 3 arranged therebetween, which form the leak detection structure 11, and a cavity 43 is arranged between the two separating sheets 41, 42.

Furthermore, a measuring device is provided which, in the example illustrated herein, has a sensor 45, a measuring cable 46 and a computing unit 50. The latter is designed to detect a pressure in the cavity 43, to evaluate it in the explained manner, and to thereby detect a leak.

As can be seen in FIG. 4, the cavity 43 is delimited in the direction of the upper side or first side U by an upper-side or first material layer 41a and in the direction of the lower side or second side L by a lower-side or second material layer 42a of the leak detection structure 11, wherein the upper-side or first material layer 41a is formed by an upper-side or first sheet 41, and the lower-side or second material layer 42a is formed by a lower-side or second sheet 42. The cavity 43 is formed in this case by a recess in a surface of the upper-side or first sheet 41 facing in the direction of the lower side or second side L, and by a recess in a surface of the lower-side or second sheet 42 facing in the direction of the upper side U or first side, which are in particular placed one on top of the other in a precisely fitting manner.

A width of the cavity 43 in a direction parallel to the first and second material layer 41a, 42b, i.e., here horizontally in the plane of the drawing, is smaller than a width of the structured sheets 3 in that same direction.

As can also be seen in FIG. 4 and as illustrated by a dash-dotted line, which in itself does not represent a structural element, in a vertical projection onto a plane parallel to the upper side U and the lower side L, a transition region between at least one of the side bars 8 and at least one of the structured sheets 3, which is hit by the dash-dotted line, overlaps in at least one section with the cavity 43 or its projection surface. Alternative embodiments are possible in which, in the mentioned vertical projection, either only at least one of the side bars 8 or only at least one of the structured sheets 3 overlap with the cavity 44 or its projection surface. These alternatives, which are not realized according to FIG. 4, are each illustrated in the form of dotted ovals.

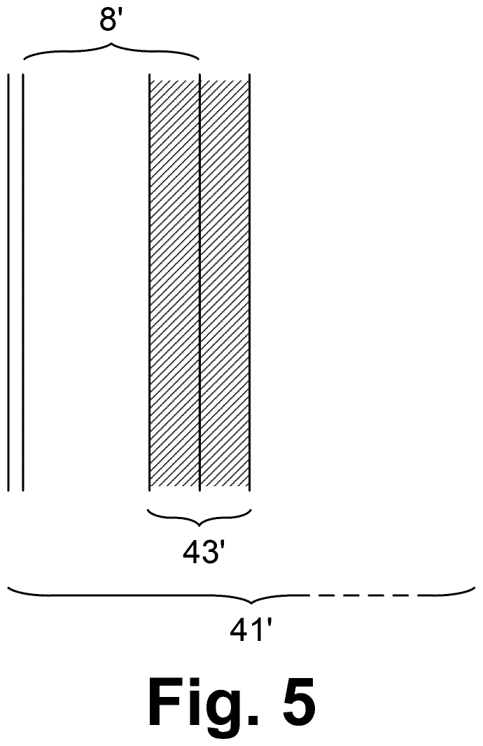

This arrangement is additionally illustrated in FIG. 5 where corresponding projections onto a plane that correspond to the plane of the paper are illustrated. Part of the projection surface of the side bar is illustrated here as 8′, part of the projection surface of the first or second sheet as 41′ and part of the projection surface of the cavity, which is assumed to be straight in this case, as 43′. The width of the cavity 43 in a direction parallel to the first and second material layer 41a, 42b is in this case in particular also horizontal in the plane of the drawing.

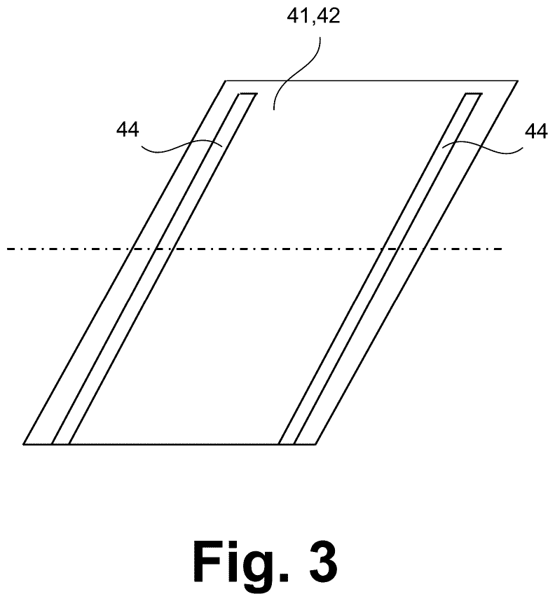

In FIG. 3 which will now be described, a corresponding upper-side or lower-side sheet 41 or 42 is illustrated in a partial perspective view, wherein the axis shown in dash-dotted lines, which runs in this case parallel to the plane of the paper, indicates the direction in which the explained width of the cavity lies.

As already illustrated in FIG. 4, the cavity 43 can be formed by a recess in one of the sheets 41, 42 or 51, 52 or by recesses in the respective sheets 41, 43 or 51, 52 facing each other. Such recesses are designated 44 in FIG. 3. Of course, several recesses 44, which can be formed in the sheets 41, 42 or 51, 52, can also be provided. The recesses 44 can be provided, for example, by milling, embossing or applying material at other locations. As mentioned, a metal structure provided within the scope of the present invention, but also a single metal structure with a cavity 43 can be provided, wherein the cavity can be cut out or formed in the metal structure, for example by casting, additive manufacturing or other methods. In the following, without any intended limitation, reference is made to two separating sheets 41, 42. However, the corresponding explanations apply equally and also to a cavity formed or provided in a metal structure.

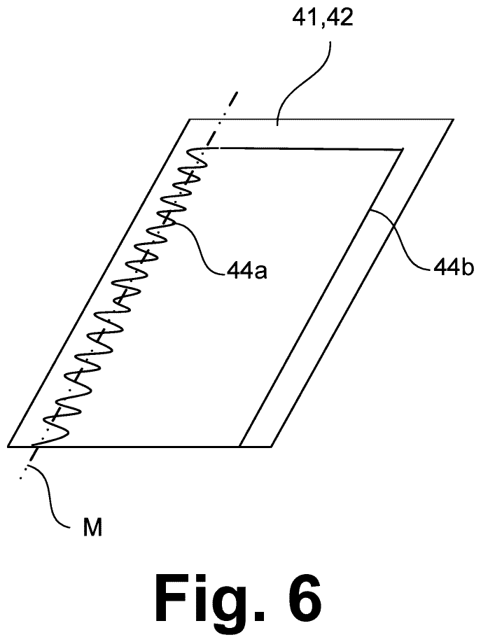

As mentioned, the one recess 44 or at least one of the recesses 44 facing each other in the two separating sheets 41, 42 can run alternately on two sides of a center line M at least in one section and lie in a plane parallel to the upper and lower side of the corresponding sheet. This is illustrated in FIG. 6 with a section 44a in which the recess runs meanderingly, whereas on an opposite side of the separating sheet 41, 42, it runs straight.

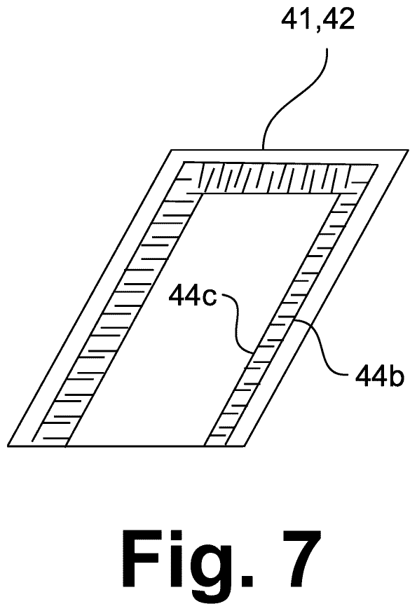

In an embodiment illustrated in FIG. 7, at least sections 44b, 44c are formed which are interlocked with one another without intermediate connection, and thereby provide two independent monitoring circuits. They can, for example, be straight or meandering.

As mentioned several times, but not illustrated separately herein for reasons of clarity, an element or a structure in the form of an, in particular, insulated cable or optical fiber can also be introduced into the cavity 43, the rupture of which can be detected by evaluating an optical signal or current signal.

1. A plate-fin heat exchanger having a heat exchanger block, wherein heat exchanger passages which each have distribution and collecting structures and one or more central structured sheets arranged between the distribution and collecting structures are arranged in the heat exchanger block, wherein separating structures are arranged between the heat exchanger passages, and the heat exchanger block is covered on a first side (U) and on a second side (L) by covering structures wherein at least one of the separating structures and/or at least one of the covering structures is designed as a leak detection structure which has a cavity formed in the leak detection structure in such a manner that the cavity is delimited in the direction of the first side (U) by a first material layer and in the direction of the second side (L) by a second material layer of the leak detection structure wherein, in a region of the leak detection structure not taken up by the cavity, the first material layer and the second material layer are connected to each other, in that a width of the cavity in a direction parallel to the first material layer and the second material layer is smaller than a width of the central structured sheet(s) of the heat exchanger passages in this direction, and in that a measuring device is provided which is designed to detect a variable correlating to a rupture of a wall of the cavity or of an element arranged in the cavity.

2. The plate-fin heat exchanger according to claim 1, wherein the variable correlating to a rupture of a wall of the cavity or of an element arranged in the cavity is a variable that characterizes an inflow of fluid into the cavity and/or an outflow of fluid from the cavity.

3. The plate-fin heat exchanger according to claim 1, wherein the first material layer is formed by a first sheet and the second material layer is formed by a second sheet, wherein the cavity is provided by a recess in a surface of the first sheet facing in the direction of the second side (L) and/or by a recess in a surface of the second sheet facing in the direction of the first side (U).

4. The plate-fin heat exchanger according to claim 3, wherein the recess is formed by embossing or material removal.

5. The plate-fin heat exchanger according to claim 1, wherein the first material layer and the second material layer are parts of an integrally formed metal structure in which the cavity is formed or provided.

6. The plate-fin heat exchanger according to claim 5, wherein the metal structure is formed using an additive manufacturing method.

7. The plate-fin heat exchanger according to claim 1, wherein the variable that correlates with a rupture of a wall of the cavity or of an element arranged in the cavity is a pressure in the cavity.

8. The plate-fin heat exchanger according to claim 1, wherein the measuring device has a computing unit or is connected or connectable to a computing unit, wherein the computing unit is designed to monitor the variable that correlates with a rupture of a wall of the cavity or of an element arranged in the cavity, and which is further designed to detect a leak in the heat exchanger block on the basis of the monitored variable.

9. The plate-fin heat exchanger according to claim 1, wherein the cavity in the leak detection structure runs alternately on two sides of a center line.

10. The plate-fin heat exchanger according to claim 9, wherein the center line runs in a predetermined arrangement to a side edge of the leak detection structure.

11. The plate-fin heat exchanger according to claim 9, wherein the center line runs in a predetermined orientation to a predicted crack propagation line and/or an expected region of crack formation, and/or wherein the cavity, which runs alternately on two sides of a center line at least in one section, runs in a meandering, sinusoidal, wave-shaped, or zigzag-shaped manner.

12. The plate-fin heat exchanger according to claim 1, wherein side bars are arranged on two sides of the central structured sheet(s) in the heat exchanger passages wherein, in a vertical projection onto a plane parallel to the first side (U) and the second side (L), a transition region between at least one of the side bars and at least one of the structured sheets overlaps with the cavity in at least one section.

13. The plate-fin heat exchanger according to claim 1, wherein the cavity is connected to a drainage device, and/or wherein temperature detection means for detecting a temperature are incorporated in the heat exchanger block and/or wherein a cable for crack detection is arranged in the cavity.

14. A method for producing a plate-fin heat exchanger, comprising the steps of:
a) forming a stack assembly that comprises a number of heat exchanger passages, wherein the heat exchanger passages are each formed by arranging a number of distribution and collecting structures and central structured sheets, wherein separating structures are each arranged between the heat exchanger passages, and wherein a covering structure each is arranged on a first side (U) and a second side (L) of the stack assembly, and
b) connecting the stack assembly to form a heat exchanger block,
wherein the steps of:
c) providing at least one of the separating structures and/or at least one of the covering structures as a leak detection structure with a cavity that is arranged in the leak detection structure in such a manner that the cavity is delimited in the direction of the first side (U) by a first material layer and in the direction of the second side (L) by a second material layer of the leak detection structure wherein, in a region of the leak detection structure not taken up by the cavity, the first material layer and the second material layer are connected to each other, and a width of the cavity in a direction parallel to the first material layer and the second material layer is smaller than a width of the central structured sheet(s) of the heat exchanger passages in that same direction, and
d) providing a measuring device which is designed to detect a variable that correlates with a rupture of a wall of the cavity or of an element arranged in the cavity, which characterizes an inflow of fluid into the cavity and/or an outflow of fluid from the cavity.

15. A method for controlling the temperature of at least one fluid, wherein a plate-fin heat exchanger according to claim 1 is used.
